(19) United States
(12) Patent Application Publication
(10) Pub. No.: US 2012/0187062 A1
(43) Pub. Date: Jul. 26, 2012

(54) Extendable Curtain Rod Structure

(75) Inventor: Daniel Arthur Sadler, III, San Diego, CA (US)

(73) Assignee: BEME INTERNATIONAL, LLC, San Diego, CA (US)

(21) Appl. No.: 13/013,701

(22) Filed: Jan. 25, 2011

(51) Int. Cl. A47H 1/022; B23P 11/00

(52) U.S. Cl. 211/123; 29/525.01

(57) ABSTRACT

A curtain rod structure provides both telescopic adjustment and a mechanism by which multiple curtain rods can be efficiently attached together. In at least one aspect, a curtain rod assembly includes: a rod member of a first type, wherein the rod member of the first type includes a connector element that attaches with an end-piece associated with the curtain rod assembly; a rod member of a second type, which is different than the first type, wherein the rod member of the second type connects with the rod member of the first type in a telescopic manner; and a fastener that attaches at either end to the connector element of the rod member of the first type; wherein the fastener has an associated stop mechanism to retain the fastener at a defined position when attached to the connector element.

### BACKGROUND

This specification relates to curtain rod assemblies, and in particular, to telescopic curtain rod assemblies.

Telescopic curtain rods typically include two types of rod members, where one of the two types of rod members fits and slides within the other of the two types of rod members. The combined rod members thus form an adjustable length curtain rod, which can be attached to a wall or ceiling using appropriate mounting brackets, and on which multiple rings can be slidably mounted to support curtains, draperies or the like. Typically, one of the two types of rod members includes an end to which a decorative finial can be attached, and at least two of such rod members, along with at least one of the other type of rod member, are provided in a set to the curtain rod purchaser. This arrangement enables mass production (and the accompanying manufacturing cost savings) of curtain rods that can be adjusted in length to fit a particular window or other mounting location at the time of installation.

### SUMMARY

A curtain rod structure provides both telescopic adjustment and a mechanism by which multiple curtain rods can be efficiently attached together. A drapery hardware set can include a telescopic rod, wall or ceiling mounting brackets and decorative finials, where the hardware set is designed such that multiple sets can be combined together to allow users to hang draperies over windows. The telescopic rods can have female threaded inserts permanently affixed to the rod ends. The insert can include a “stop” feature so that a male threaded screw will stop at a desired depth. The male threaded screw can have a slot formed on both ends for ease of tightening and loosening by users. An additional drapery set can be attached to the exposed male screw to extend the length of the curtain rod. More drapery sets can be added by the same method to allow users to cover windows of any width. Once the user has their desired hardware length, decorative finials, with a threaded hole can be attached to the ends of the drapery rod.

In at least one aspect, a curtain rod assembly includes: a rod member of a first type, wherein the rod member of the first type includes a connector element that attaches with an end-piece associated with the curtain rod assembly; a rod member of a second type, which is different than the first type, wherein the rod member of the second type connects with the rod member of the first type in a telescopic manner; and a fastener that attaches at either end to the connector element of the rod member of the first type; wherein the fastener has an associated stop mechanism to retain the fastener at a defined position when attached to the connector element.

In some implementations, the fastener cart attach at either end to the end-piece. The rod member of the second type can include a connector element that attaches with the end-piece associated with the curtain rod assembly, the rod member of the second type can have an outer diameter less than an inner diameter of the rod member of the first type, such that the rod member of the second type fits and slides within the rod member of the first type, and the fastener can attach at either end to the connector element of the rod member of the second type.

The end-piece can include a decorative finial. The fastener can include a double-ended screw. The connector element can include the stop mechanism. The connector element can include a cylinder having threads on an inner surface thereof. The stop mechanism can include a plate located at an interior end of the cylinder. Moreover, the curtain rod assembly can include a second rod member of the first type, wherein the second rod member of the first type includes a connector element that attaches with the end-piece associated with the curtain rod assembly, and the fastener attaches at either end to the connector element of the second rod member of the first type.

In at least another aspect, a method includes: providing an assortment of different curtain rod end-pieces; and separately providing curtain rod assemblies, each of the curtain rod assemblies including a rod member of a first type, a rod member of a second type, which is different than the first type, and a fastener; wherein the rod member of the first type is connectable with each of the assortment of different curtain rod end-pieces using the fastener, the rod member of the second type is connectable with the rod member of the first type in a telescopic manner, and rod members of the first type provided separately in the curtain rod assemblies are connectable with each other using the fastener. The rod member of the second type can be connectable with each of the assortment of different curtain rod end-pieces using the fastener, and rod members of the second type provided separately in the curtain rod assemblies can be connectable with each other using the fastener.

In at least another aspect, a method includes: obtaining curtain rod end-pieces; obtaining separately packaged curtain rod assemblies, each of the curtain rod assemblies including a rod member of a first type, a rod member of a second type, which is different than the first type, and a fastener; connecting the curtain rod assemblies to each other using one of the fasteners; and connecting one of the curtain rod end-pieces with the connected curtain rod assemblies using another of the fasteners. Connecting the curtain rod assemblies to each other can include: connecting each of the rod members of the second type to the respective rod members of the first type in a telescopic manner; and connecting the rod members of the second type to each other using the one of the fasteners. Moreover, each of the curtain rod assemblies can include an additional rod member of the first type, and connecting the curtain rod assemblies to each other can include: connecting each of the rod members of the second type to two rod members of the first type in a telescopic manner; and connecting rod members of the first type to each other using the one of the fasteners.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a prior approach to connecting drapery hardware sets together.

FIGS. 2A-2C show a new approach to connecting drapery hardware sets together.

FIGS. 3A and 3B show an example of an extendable curtain rod structure.

FIGS. 4A and 4B show another example of an extendable curtain rod structure.

FIG. 5 shows a process of supplying connectable drapery hardware sets.

FIG. 6 shows a process of connecting drapery hardware sets.

Like reference symbols in the various drawings indicate like elements.

### DETAILED DESCRIPTION

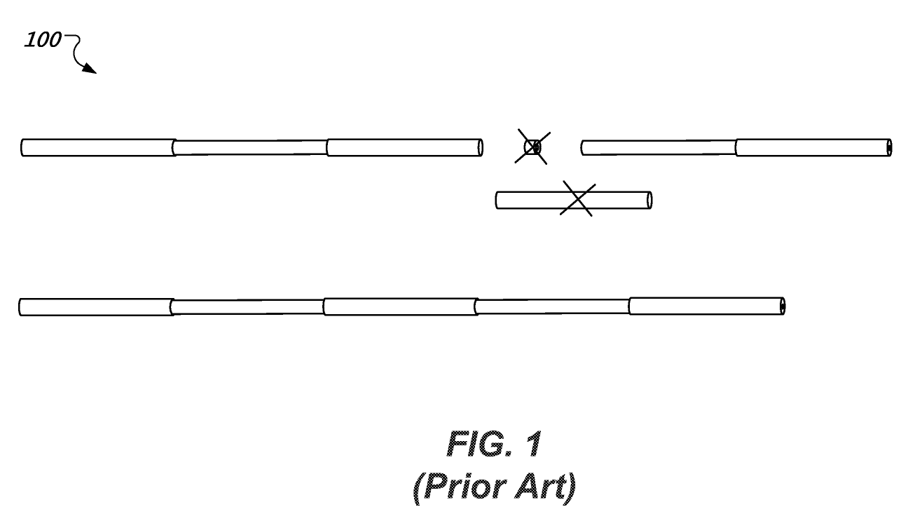

FIG. 1 shows a prior approach to connecting drapery hardware sets 100 together. Specifically, when a consumer has a window that spans a distance greater than what a single drapery hardware set 100 would cover, the consumer would purchase two or more draper hardware sets 100 and connect them together to achieve the distance. However, upon connecting the drapery hardware sets 100, at least one rod member, and possibly a connector element, of the drapery hardware set 100 would be discarded as they would be unneeded. If a fastener (not shown) is further needed to connect the drapery hardware sets 100 together, the consumer would have to purchase this additionally. Thus, the prior approach at connecting the drapery hardware sets 100 generates unneeded waste and extra cost to the consumer and the manufacturer.

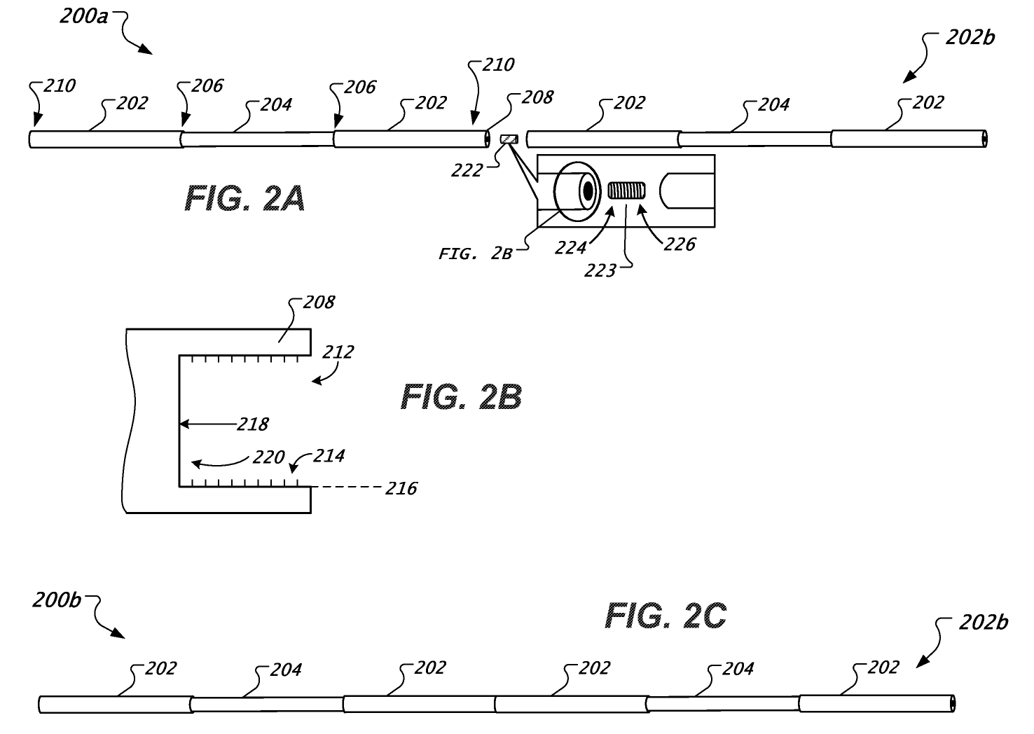

FIGS. 2A-2C show an approach to connecting drapery hardware sets 200 together, shown as drapery hardware sets 200a and 200b. The drapery hardware set 200 includes two first rod members 202 and one second rod member 204. The second rod member 204 connects with the first rod members 202 at a first end 206 of the first rod members 202 in a telescopic manner. Specifically, the second rod member 204 has an outer diameter that is less than an inner diameter of the first rod members 202 such that the second rod member 204 slides within the first rod members 202 in a telescopic manner.

The first rod members 202 include a connector element 208. The connector element 208 is located at a second end 210 of the first rod members 202 that is opposite the first end 206. The connector element 208 includes a cylinder 212 having threads 214 on an inner surface 216 of the connector element 208, as shown in FIG. 2b. The connector element 208 further includes a plate 218 located at an interior end 220 of the cylinder 212.

To connect the drapery hardware sets 200 together, a fastener 222 is employed. The fastener 222 is a double-ended screw having threads 223 and includes first 224 and second 226 opposed ends. The fastener 222 attaches at either the first end 224 or the second end 226 to the connector element 208 of the first rod members 202. When the fastener 222 is attached to the connector elements 208 of first rod members 202 of both drapery hardware sets 200a and 200b, the drapery hardware sets 200 are connected together, as shown in FIG. 2c.

The drapery hardware set 200 also had associated end-pieces (not shown) that are often sold separately. The end-pieces (not shown) attach to the connector elements 208 of the first rod members 202. More specifically, the fastener 222 attaches at either the first end 224 or the second end 226 to the end pieces (not shown). The end-pieces (not shown) may be employed with a single drapery hardware set 200 or when two or more drapery hardware sets 200 are connected together, as described above. Specifically, the first rod members 202 of the drapery hardware sets 200 are connected together via the fastener 222 and the end-pieces (not shown) are connected to the remaining first rod members 202 of the drapery hardware sets 200. In some implementations, many different types of end pieces (not shown) can be made available, all of which connect to the first rod members 202 by means of the fastener 222. For example, the end-pieces can be decorative finials of many different aesthetic designs.

To retain the fastener 222 at a defined position when attached to the connector element 208, the fastener 222 has a stop mechanism associated therewith. The stop mechanism ensures that the fastener 222 is able to attach to the connector element 208 of the first rod members 202 of each drapery hardware sets 200 at the same time. Specifically, when the fastener 222 is attached to the connector element 208 of the first rod member 202 of one of the drapery hardware sets 200, the stop mechanism provides that a portion of the fastener 222 always extends beyond the connector element 208 to have a length such that this portion of the fastener 222 is able to attach to the connector element 208 of the first rod member 202 of the other drapery hardware set 200. In some implementations, the plate 218 of the connector element 208 is the stop mechanism associated with the fastener 222. In other implementations, the fastener 222 includes a protrusion (not shown) extending from the threads 223 having a diameter that is larger than a diameter of the threads 223 and the cylinder 212 of the connector element 208. Thus, in these implementations, the protrusion (not shown) is the stop mechanism associated with the fastener 222.

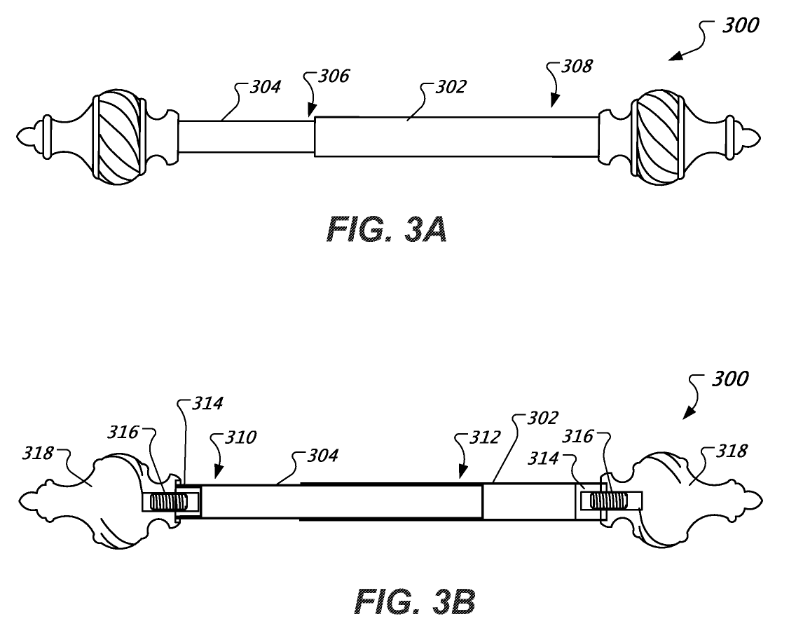

FIGS. 3A and 3B show an example of an extendable curtain rod structure. Hardware drapery set 300 includes one first rod member 302 and one second rod member 304. The first rod member 302 has first 306 and second 308 opposed ends. Similarly, the second rod member 304 has first 310 and second 312 opposed ends. The second rod member 304 connects with the first rod member 302 at the first end 306 of the first rod member 302 and the second end 312 of the second rod member 304. Similar to the drapery hardware set 200 of FIG. 2, the second rod member 304 has an outer diameter that is less than an inner diameter of the first rod member 302 such that the second rod member 304 slides within the first rod member 302 in a telescopic manner.

The first and second rod members 302 and 304 have a connector element 314 similar to the connector element 208 of FIG. 2. The connector element 314 is located at the second end 308 of the first rod member 302 and the first end 310 of the second rod member 304. The hardware drapery set 300 further includes a fastener 316 similar to the fastener 222 of FIG. 2. The fastener 316 attaches at either the first end or the second end to the connectors elements 314 of the first 302 and the second 304 rod members.

The drapery hardware set 300 further includes end-pieces 318. The end-pieces 318 attach to the connector elements 314 of the first 302 and the second 304 rod members. More specifically, the fastener 316 attaches at either the first end or the second end to the end pieces 318. In some implementations, the end-pieces 318 are decorative finials.

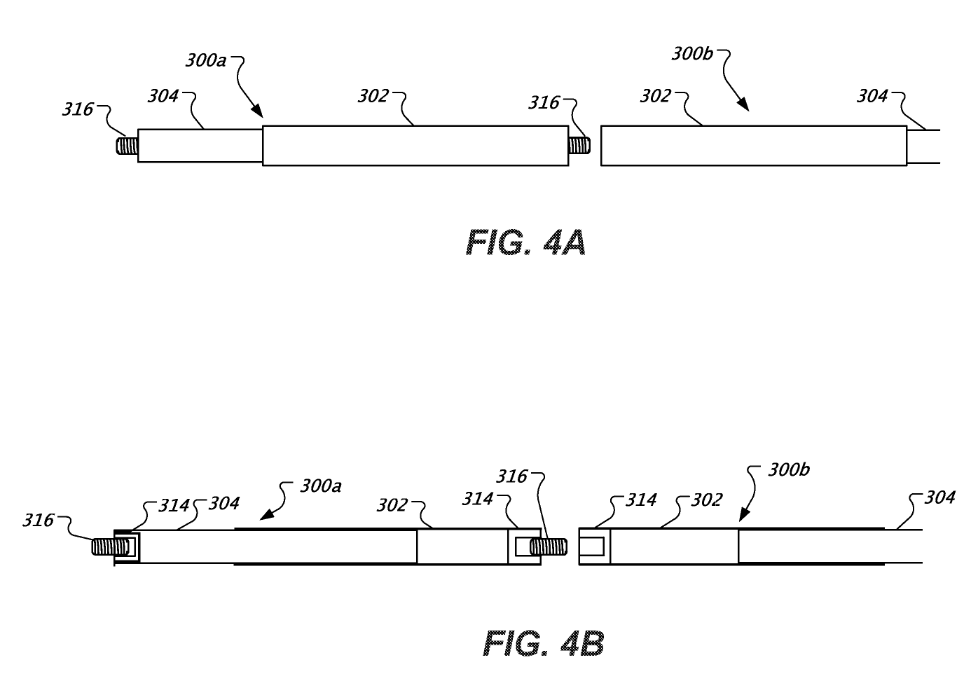

FIGS. 4A and 413 show the drapery hardware set 300 of FIGS. 3A and 313, now shown as drapery hardware set 300a connected with an additional drapery hardware set 300b. Specifically, the fastener 316 attaches to the connector element 314 of the first rod member 302 of a first drapery hardware set 300a and further attaches to the connector element 314 of the first rod member 302 of the additional drapery hardware set 300b. The end-piece 318 may be attached to the second rod members 304 of each drapery hardware set 300 via an additional fastener 316. In some implementations, any combination of first 302 and second 304 rod members of either drapery hardware set 300 may be connected via the fastener 316. Specifically, each connector element 314 of each first 302 and second 304 rod member is substantially the same such that the fastener 316 attaches to any connector element 314 of the first 302 and second 304 rod members. This allows for connection combinations such as the second rod members 304 being connected together via the fastener 316 or the second rod member 304 of one of the drapery hardware sets 300 being connected to the first rod member 302 of the other drapery hardware set 300 via the fastener 316. However, for aesthetic reasons, usually only like rod members are connected together. Moreover, the fasteners 316 and 222 can be of conventional gauge and thread count known in the art, which can provide significant cost advantages in the manufacture of the drapery hardware sets that can be connected together, while also minimizing the amount and cost of any extra piece (i.e., one extra fastener for two sets sold with two fasteners each) that is not used from the separately purchased drapery hardware sets to be connected together. Alternatively, the fasteners can be sold separately.

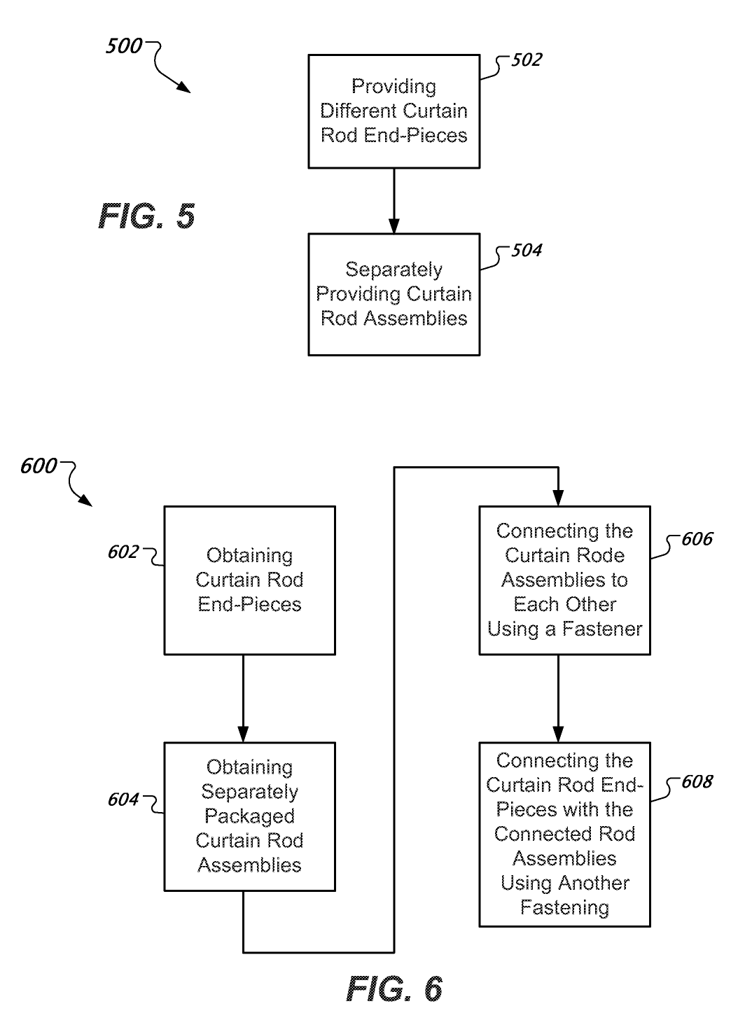

FIG. 5 shows a flow chart 500 of supplying connectable drapery hardware sets. At 502, an assortment of different curtain rod end-pieces are provided. At 504, curtain rod assemblies are separately provided. Each of the curtain rod assemblies include a rod member of a first type, a rod member of a second type, which is different than the first type, and a fastener. The rod member of the first type is connectable with each of the assortment of different curtain rod end-pieces using the fastener, the rod member of the second type is connectable with the rod member of the first type in a telescopic manner, and rod members of the first type provided separately in the curtain rod assemblies are connectable with each other using the fastener.

FIG. 6 shows a flow chart 600 of connecting connectable drapery hardware sets. At 602, curtain rod end-pieces are obtained. At 604, separately packaged curtain rod assemblies are obtained. Each of the curtain rod assemblies include a rod member of a first type, a rod member of a second type, which is different than the first type, and a fastener. At 606, the curtain rod assemblies are connected to each other using one of the fasteners. At 608, one of the curtain rod end-pieces are connected with the connected curtain rod assemblies using another of the fasteners.

A number of embodiments of the invention have been described. Nevertheless, it will be understood that various modifications may be made without departing from the spirit and scope of the invention. Accordingly, other embodiments are within the scope of the following claims.

What is claimed is:

1. A curtain rod assembly comprising:
a rod member of a first type, wherein the rod member of the first type comprises a connector element that attaches with an end-piece associated with the curtain rod assembly;
a rod member of a second type, which is different than the first type, wherein the rod member of the second type connects with the rod member of the first type in a telescopic manner; and
a fastener that attaches at either end to the connector element of the rod member of the first type;
wherein the fastener has an associated stop mechanism to retain the fastener at a defined position when attached to the connector element.

2. The curtain rod assembly of claim 1, wherein the fastener attaches at either end to the end-piece.

3. The curtain rod assembly of claim 2, wherein the rod member of the second type comprises a connector element that attaches with the end-piece associated with the curtain rod assembly, the rod member of the second type has an outer diameter less than an inner diameter of the rod member of the first type, such that the rod member of the second type fits and slides within the rod member of the first type, and the fastener attaches at either end to the connector element of the rod member of the second type.

4. The curtain rod assembly of claim 2, wherein the end-piece is a decorative finial.

5. The curtain rod assembly of claim 2, wherein the fastener comprises a double-ended screw.

6. The curtain rod assembly of claim 5, wherein the connector element comprises the stop mechanism.

7. The curtain rod assembly of claim 6, wherein the connector element comprises a cylinder having threads on an inner surface thereof.

8. The curtain rod assembly of claim 7, wherein the stop mechanism comprises a plate located at an interior end of the cylinder.

9. The curtain rod assembly of claim 2, comprising a second rod member of the first type, wherein the second rod member of the first type comprises a connector element that attaches with the end-piece associated with the curtain rod assembly, and the fastener attaches at either end to the connector element of the second rod member of the first type.

10. A method comprising:
providing an assortment of different curtain rod end-pieces; and
separately providing curtain rod assemblies, each of the curtain rod assemblies including a rod member of a first type, a rod member of a second type, which is different than the first type, and a fastener;
wherein the rod member of the first type is connectable with each of the assortment of different curtain rod end-pieces using the fastener, the rod member of the second type is connectable with the rod member of the first type in a telescopic manner, and rod members of the first type provided separately in the curtain rod assemblies are connectable with each other using the fastener.

11. The method of claim 10, wherein the rod member of the second type is connectable with each of the assortment of different curtain rod end-pieces using the fastener, and rod members of the second type provided separately in the curtain rod assemblies are connectable with each other using the fastener.

12. A method comprising:
obtaining curtain rod end-pieces;
obtaining separately packaged curtain rod assemblies, each of the curtain rod assemblies including a rod member of a first type, a rod member of a second type, which is different than the first type, and a fastener;
connecting the curtain rod assemblies to each other using one of the fasteners; and
connecting one of the curtain rod end-pieces with the connected curtain rod assemblies using another of the fasteners.

13. The method of claim 12, wherein connecting the curtain rod assemblies to each other comprises:
connecting each of the rod members of the second type to the respective rod members of the first type in a telescopic manner; and
connecting the rod members of the second type to each other using the one of the fasteners.

14. The method of claim 12, wherein each of the curtain rod assemblies includes an additional rod member of the first type, and connecting the curtain rod assemblies to each other comprises:
connecting each of the rod members of the second type to two rod members of the first type in a telescopic manner; and
connecting rod members of the first type to each other using the one of the fasteners.
